(19) United States
(12) Patent Application Publication
(10) Pub. No.: US 2009/0252249 A1
(43) Pub. Date: Oct. 8, 2009

(54) DETECTING METHOD OF MULTIPLE-INPUT MULTIPLE-OUTPUT SYSTEM

(75) Inventors: Kyeong-Pyo Kim, Daejon (KR); Woo-Yong Lee, Daejon (KR); Hyun Lee, Daejon (KR); Jin-Kyeong Kim, Daejon (KR); Yong-Sun Kim, Daejon (KR)

Correspondence Address: Muncy, Geissler, Olds & Lowe, PLLC, P.O. BOX 1364, FAIRFAX, VA, 22038-1364, US

(73) Assignee: Electronic and Telecommunications Research Institute, Daejon (KR)

(21) Appl. No.: 12/095,814

(22) PCT Filed: Nov. 28, 2006
(86) PCT No.: PCT/KR06/05058

§ 371 Date: Oct. 16, 2008

(30) Foreign Application Priority Data
Dec. 1, 2005 (KR) 10-2005-0116134
May 26, 2006 (KR) 10-2006-0047744

(51) Int. Cl. H04B 7/02

(52) U.S. Cl. 375/267

(57) ABSTRACT

A detecting method of a multiple-input multiple-output system includes the steps of: a) canceling interference between transmit signals by assigning weight values to signals received through a plurality of antennas, and determining K optimal antenna signals through channel gain estimation; b) calculating L transmit signal estimation values by quantizing the optimal antenna signals according to a predefined constellation size of L; c) calculating L residual antenna signals, in which interference of the transmit signal estimation values is removed from the received signals using the L Tx signal estimation values; d) calculating L residual transmit signal estimation values by quantizing the L residual antenna signals according to the predefined constellation size; and e) creating K×L estimated transmit signal candidate groups by repeating the calculation of the L residual transmit signal estimation values for each of the K optimal antenna signals, and detecting transmit signals from the estimated transmit signal candidate groups.

### TECHNICAL FIELD

The present invention relates to a detecting method of a multiple-input multiple-output system; and, more particularly, to a detecting method of a multiple-input multiple-output system, including the steps of: determining K optimal transmit (Tx) signals among total of M Tx signals at a receiver of the MIMO system, and letting the estimation values of the K optimal Tx signals be each of the values in the signal constellation; determining M−1 antenna signals in which interference of each of the optimal antenna signals is removed, and calculating M−1 residual Tx signal estimation values; repeating this process for all K optimal Tx signals; and applying a maximum likelihood (ML) detection scheme to K×L estimated Tx signal candidate groups.

### BACKGROUND ART

In recent years, as the wireless communication service is changing from a voice service to a high-quality multimedia service, studies on data transmission technologies are actively in progress in order to transmit a larger amount of data at a lower error rate more rapidly than ever.

The data transmission, however, is greatly influenced by wireless communication environment, e.g., signal fading, interference and noise. Specifically, the data transmission is influenced by serious signal distortion caused by combination of signals having different phases and amplitudes received through different paths due to multipath fading.

To solve the signal fading, a multiple-input multiple-output (hereinafter, referred to as a MIMO) system has been proposed.

FIG. 1 is a block diagram of a MIMO system to which the present invention is applied.

Referring to FIG. 1, the MIMO system is a wireless communication system that transmits/receives different data through M transmit (Tx) antennas 1 and N receive (Rx) antennas 2, instead of using wide frequency bandwidth, in order to increase a data rate and a transmission capacity in the wireless communication environment with limited frequency resources.

In the MIMO system, signals received at the Rx antennas 2 are expressed as Eq. 1 below.

r=Hx+n Eq. 1

where x is Tx signals transmitted differently through the M Tx antennas 1, H is multipath radio channels that the Tx signals x pass through before they are received at the Rx antennas 2, r is Rx signals received at the N Rx antennas 2 over the multipath radio channels H, and n is noise signals added to the Rx antennas 2.

The Tx signals x are expressed as x=[x₁x₂ . . . x_{M-1}x_{M}]^{T}, the Rx signals r are expressed as r=[r₁r₂ . . . r_{N-1}r_{N}]^{T}, and the multi-path radio channels H are expressed as H=[h₁h₂ . . . h_{M-1}h_{M}].

In addition, the noise signals n are expressed as n=[n₁n₂ . . . n_{N-1}n_{N}]^{T} and have a complex Gaussian distribution in which a mean of the respective components is zero and a variation is N₀/2 in each order.

Meanwhile, the receiver of the MIMO system uses a maximum likelihood (ML) detection scheme. The ML detection scheme is to select an input signal having the minimum squared Euclidean distance, which is expressed in Eq. 2, among the possible combinations of the Tx signals x.

Referring to FIG. 1 and Eq. 1, the ML detection scheme determines a solution \hat{x} using Eq. 2 below.

$$\hat{x} = {argmin}_{x} {‖ r - Hx ‖}^{2} , x ∈ {C}^{L} \qquad Eq . 2$$

In Eq. 2, C^{L} is a vector set that the Tx signals x can have within a signal constellation. The number of elements of the vector set is L^{M}, where L is a constellation size and M is the number of total transmit antenna signals.

In the MIMO system, the ML detection scheme exhibits the optimal performance in terms of a bit error rate (BER). However, as can be seen from Eq. 2, the ML detection scheme must calculate the square of the Euclidean distance for all possible Tx signals and compare the calculated values from one another. Thus, the operation of Eq. 2 must be performed L^{M} times.

As the constellation size L or the number M of the Tx antennas 1 increases, the processing time and complexity exponentially increase, so that the practical implementation is difficult.

Meanwhile, a successive interference cancellation (SIC) scheme is proposed to reduce the complexity of the ML detection scheme. The SIC scheme is carried out as follows.

In the first step, interference between Tx signals is cancelled by linearly assigning weight values to Rx signals, and the Tx signals are separated according to Tx antennas 1.

In the second step, the interference-cancelled signals are randomly sorted, for example, in ascending order of signal-to-noise ratio (SNR), and a signal to be first removed is determined.

In the third step, an estimation value of the Tx signal is calculated through quantization of the determined signal into the signal constellation, and the influence of the calculated estimation value is removed from the Rx signal.

Then, the first to third steps are repeated until all Tx signals are detected.

Compared with the ML detection scheme, the SIC method can greatly reduce the amount of calculation and complexity. However, because noise increases when the interference between the Tx signals is removed in the first step, the BER performance is degraded.

Further, because the entire performance of the SIC scheme is greatly dependent on the reliability of the initially detected signal, the sorting step plays an important role.

That is, the ML detection scheme has a problem of the complexity and the SIC scheme has a problem of the degraded BER performance. Therefore, there is a demand for a detecting method that can provide the reduced complexity and the improved BER performance and can easily implement the MIMO system.

### DISCLOSURE

### Technical Problem

It is, therefore, an object of the present invention to provide a detecting method of a MIMO system, including the steps of: determining K optimal transmit (Tx) signals among total of M of Tx signals at a receiver of the MIMO system, and letting the estimation values of the K optimal Tx signals be each of the values in the signal constellation; determining M−1 antenna signals in which interference of each of the optimal antenna signals is removed, and calculating M−1 residual Tx signal estimation values; repeating this process for all K optimal Tx signals; and applying a maximum likelihood (ML) detection scheme to K×L estimated Tx signal candidate groups.

### Technical Solution

In accordance with one aspect of the present invention, there is provided a detecting method of a MIMO system using multipath radio channels, including the steps of: a) canceling interference between transmit antenna signals by assigning weight values to signals received through a plurality of antennas, and determining K optimal transmit antenna signals among M transmit antenna signals based on a certain metric, where M and K are arbitrary positive integers; b) calculating transmit antenna signal estimation values for one transmit antenna signal among K optimal transmit antenna signals by quantizing the one transmit antenna signal to every possible value on a signal constellation with the size of L, where L is an arbitrary positive integer; c) calculating L sets of the other (M−1) transmit antenna signals by removing interferences, the L transmit antenna signal estimation values, from the received signals; d) calculating L sets of M−1 transmit signal estimation values by quantizing the L sets of M−1 transmit antenna signals according to the predefined constellation size; and e) creating K×L estimated transmit signal candidate groups by repeating the calculation of the L sets of M−1 transmit antenna signal estimation values for each of the K optimal antenna signals, and detecting transmit antenna signals from the estimated transmit signal candidate groups.

### ADVANTAGEOUS EFFECTS

In accordance with the present invention, the complexity of the ML detection scheme can be remarkably reduced and the BER performance can be greatly improved.

Furthermore, the MIMO system capable of solving the problem of the limited frequency resources can be easily implemented.

### DESCRIPTION OF DRAWINGS

The above and other objects and features of the present invention will become apparent from the following description of the preferred embodiments given in conjunction with the accompanying drawings, in which:

FIG. 1 is a block diagram of a MIMO system to which the present invention is applied; and

FIG. 2 is a flowchart illustrating a detecting method of a MIMO system according to an embodiment of the present invention.

### BEST MODE FOR THE INVENTION

Other objects and aspects of the invention will become apparent from the following description of the embodiments with reference to the accompanying drawings, which is set forth hereinafter.

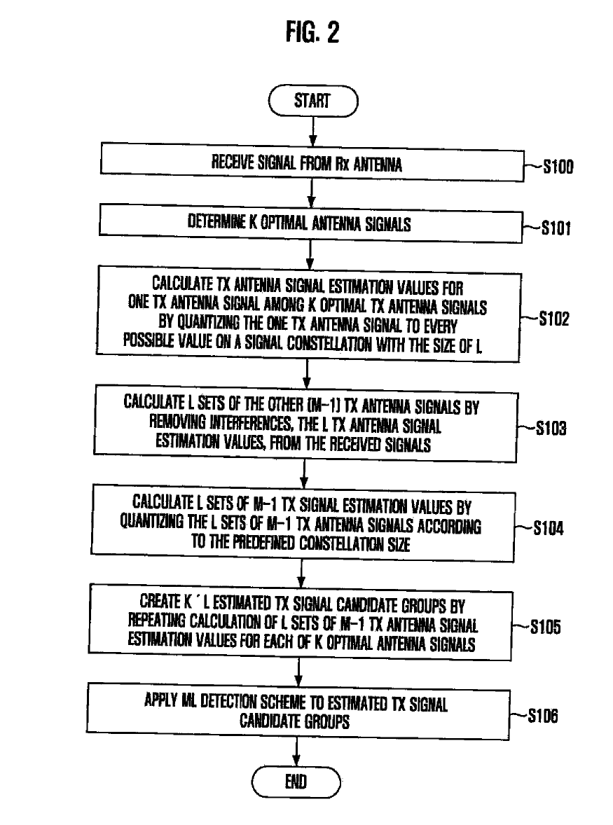

FIG. 2 is a flowchart illustrating a detecting method of a MIMO system according to an embodiment of the present invention.

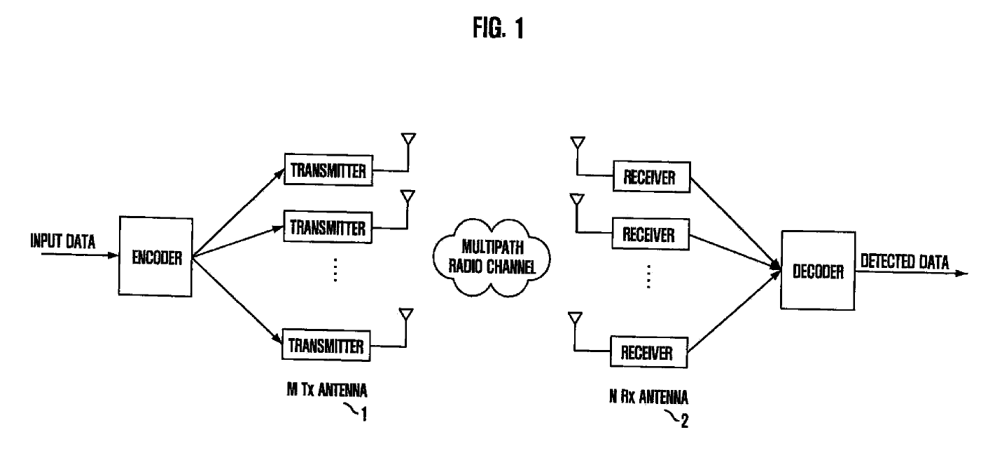

Since the present invention is applied to the MIMO system of FIG. 1, a detailed description of the MIMO system will be omitted.

Referring to FIG. 2, when the Rx antennas 2 in the receiver of the MIMO system receive signals in step S100, K (1≦K—M) antenna signals which are considered to be optimal based on a certain metric or to have the highest reliability (hereinafter, referred to as “optimal antenna signals”) are determined among the possible Tx signals of the Tx antennas 1 in step S101. That is, the receiver of the MIMO system cancels the interference between the Tx signals by assigning weight values to the Rx signals and then determines the K optimal antenna signals by estimating channel gains using SNR, log likelihood ratio, or preamble.

Step S101 will be described in detail with reference to Eqs. 3 to 5 below.

W=(H_{H}H+σ²ₙI)⁻¹H^{H},(MMSE)

W=(H^{H}H)⁻¹H^{H},(ZF) Eq. 3

y=Wr=WHx+Wn Eq. 4

yₙ=wₙr Eq. 5

Eq. 3 represents a weight matrix W to be multiplied by the Rx signal r in order to cancel the interference between the Rx signals. The weight matrix W is expressed as W=[w₁w₂ . . . w_{M}]^{T}.

The weight matrix W is calculated using a minimum mean square error (MMSE) scheme or a zero forcing (ZF) scheme. Since the MMSE scheme and the ZF scheme are well known, their detailed description will be omitted.

Eq. 4 represents the interference-cancelled signal y obtained by multiplying the Rx signal r by the weight matrix W of Eq. 3.

Eq. 5 represents a n^{th} signal yₙ extracted from the signal y. Since the number of the Tx antennas 1 is M, 1≦n≦M.

Specifically, the receiver of the MIMO system determines the K optimal antenna signals based on a certain metric, e.g., the SNRs or log likelihood ratios of the M extracted signals {y₁, . . . , yₙ, . . . , y_{M}} given by Eq. 5. For convenience, it will be assumed that one of the K optimal antenna signals is an n^{th} extracted signal yₙ and is applied to following equations. Since the application of the remaining (K−1) optimal antenna signals is identical to that of the extracted signal yₙ, its detailed description will be omitted.

The receiver of the MIMO system determines the K optimal antenna signals among the Tx signals in step S101, and quantizes the K optimal antenna signals into all possible values of a predefined constellation size L to calculate L optimal Tx signal estimation values in step S102. That is, the receiver of the MIMO system calculates the L optimal Tx signal estimation values with respect to the n^{th} extracted signal yₙ, and calculates L optimal Tx signal estimation values with respect to each of the remaining (K−1) optimal antenna signals.

Step S102 will be described in more detail with reference to Eq. 6 below.

\hat{x}ₙ=Q(yₙ) Eq. 6

Eq. 6 represents the optimal Tx signal estimation value \hat{x}ₙ obtained by quantizing the n^{th} extracted signal yₙ according to the predefined constellation size L.

In this manner, the receiver of the MIMO system calculates the L optimal Tx signal estimation value \hat{x}ₙ by substituting all values of the constellation, that is, the first to last signals whose number is equal to the constellation size L.

Meanwhile, the receiver of the MIMO system calculates the L sets of M−1 optimal Tx signal estimation values with respect to each of the K optimal antenna signals in step S102, and calculates L residual Rx signals in which the interference of the optimal Tx signal estimation values is cancelled from all Rx signals in step S103.

Step S102 will be described in more detail with reference to Eqs. 7 to 10.

r′=r−hₙ\hat{x}ₙ Eq. 7

H′=[h₁h₂ . . . hₙ₋₁hₙ₊₁ . . . h_{M}] Eq. 8

W′=(H′^{H}H′+σ²ₙI)⁻¹H′^{H},(MMSE)

W′=(H′^{H}H)⁻¹H′^{H},(ZF) EQ. 9

y′=W′r′ Eq. 10

Eq. 7 represents the cancellation of the interference of the optimal Tx signal estimation values, calculated in Eq. 6, from all Tx signals. Since the calculation of the optimal Tx signal estimation value \hat{x}ₙ is performed as many times as the constellation size L in Eq. 7, the residual Rx signals r′ are generated as many as the constellation size L.

Eq. 8 represents an interference-cancelled channel matrix H′ for removing the influence of the optimal Tx signal estimation value from the multipath radio channels H. That is, it can be seen from Eq. 8 that hₙ is removed.

Eq. 9 represents a weight matrix W′ calculated using the multipath radio channel matrix H′ of Eq. 8, in which the influence of the optimal Tx signal estimation value is removed. Since the weight matrix of Eq. 9 is calculated in the same manner as Eq. 8, its detailed description will be omitted. Using Eq. 9, the weight matrix W′ for canceling the interference of the Tx signals, in which the influence of the optimal Tx signal estimation signal is removed, can be obtained.

Eq. 10 represents the residual antenna signal obtained by multiplying the weight matrix W′ of Eq. 9 by the residual Rx signal r′ of Eq. 7. In Eq. 10, L residual antenna signals y′ are calculated because the number of the sets of the residual Rx signals r′ with the size of M−1 is L.

Meanwhile, in step S103, the receiver of the MIMO system calculates the L sets of M−1 residual antenna signals in which the interference of the optimal Tx signal estimation values is removed. In step S104, L sets of M−1 estimated Tx signal values (hereinafter, referred to as residual Tx signal estimation values) are calculated by quantizing the residual antenna signals into the possible values of the predefined constellation size L.

Step S104 will be described below with reference to Eq. 11 below.

\hat{x}₁=Q(y′₁), . . . , \hat{x}ₙ₋₁=Q(y′ₙ₋₁),\hat{x}ₙ₊₁=Q(y′ₙ₊₁), . . . \hat{x}_{M}=Q(y′_{M}) Eq. 11

Eq. 11 represents the residual Tx signal estimation value calculated using the residual antenna signals. It can be seen that \hat{x}ₙ=Q(y′ₙn) is removed.

In addition, Eq. 11 determines the L sets of M−1 residual Tx signal estimation values because the residual antenna signals y′ are generated as many as the constellation size L.

When the receiver of the MIMO system selects the K optimal antenna signals in step S101, steps S102 to S104 are repeated for each of the K optimal antenna signals. In other words, steps S102 to S104 are repeated until the L sets of M−1 residual Tx signal estimation values are determined.

In step S105, as the results of the K-time repetition, the receiver of the MIMO system generates estimated Tx signal candidate groups as many as the L residual Tx signal estimation values in each of the K optimal antenna signals. That is, the number of the estimated Tx signal candidate groups created is K×L, which is the product of the number of the optimal antenna signals and the number of the residual Tx signal estimation values.

In step S106, the receiver of the MIMO system detects the Tx signals by applying the ML detection scheme to the signals of the estimated Tx signal candidate groups. Since the ML detection scheme is well known, its detailed description will be omitted.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

The present application contains subject matter related to Korean patent application No. 2005-0116134 and 2006-0047744, filed with the Korean Intellectual Property Office on Dec. 1, 2005 and May 26, 2006, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A detecting method of a multiple-input multiple-output system using multipath radio channels, comprising the steps of:
a) canceling interference between transmit antenna signals by assigning weight values to signals received through a plurality of antennas, and determining K optimal transmit antenna signals among M transmit antenna signals based on a certain metric, where M and K are arbitrary positive integers;
b) calculating transmit antenna signal estimation values for one transmit antenna signal among K optimal transmit antenna signals by quantizing the one transmit antenna signal to every possible value on a signal constellation with the size of L, where L is an arbitrary positive integer;
c) calculating L sets of the other (M−1) transmit antenna signals by removing interferences, the L transmit antenna signal estimation values, from the received signals;
d) calculating L sets of M−1 transmit signal estimation values by quantizing the L sets of M−1 transmit antenna signals according to the predefined constellation size; and
e) creating K×L estimated transmit signal candidate groups by repeating the calculation of the L sets of M−1 antenna signal estimation values for each of the K optimal antenna signals, and detecting transmit antenna signals from the estimated transmit signal candidate groups.

2. The detecting method as recited in claim 1, wherein the K optimal antenna signals are determined through the channel gain estimation using a signal-to-noise ratio in the step a).

3. The detecting method as recited in claim 1, wherein the K optimal antenna signals are determined through the channel gain estimation using a log likelihood ratio in step a).

4. The detecting method as recited in claim 1, wherein the K optimal antenna signals are determined through the channel gain estimation using a preamble.

5. The detecting method as recited in claim 1, wherein the weight vales in the step a) are calculated using a multipath radio channel matrix in accordance with one of a minimum mean square error (MMSE) scheme and a zero forcing (ZF) scheme.

6. The detecting method as recited in claim 1, wherein the residual antenna signals in the step c) are calculated by canceling the interference of the transmit signal estimation values and assigning the weight values thereto.

7. The detecting method as recited in claim 6, wherein the weight values are calculated using a multipath radio channel matrix in which the interference of the transmit signal estimation values is removed in accordance with one of a minimum mean square error (MMSE) scheme and a zero forcing (ZF) scheme.

8. The detecting method as recited in claim 1, wherein the step e) detects the transmit signals by applying a maximum likelihood (ML) detection scheme to the estimated transmit signal candidate groups.

9. The detecting method as recited in claim 1, wherein the K optimal antenna signals are determined randomly.

10. The detecting method as recited in claim 1, wherein the K optimal antenna signals are determined in order.
